(19) United States
(12) Patent Application Publication
(10) Pub. No.: US 2026/0254615 A1
(43) Pub. Date: Aug. 27, 2026

(54) PACKET NETWORK PATH TRACKING THROUGH IPV6 EXTENSION HEADER

(71) Applicant: Lenovo Global Technology (United States) Inc., Morrisville, NC (US)

(72) Inventors: George-Andrei Stanescu, Ilfov (RO); Fred Allison Bower, III, Durham, NC (US)

(21) Appl. No.: 19/061,699

(22) Filed: Feb. 24, 2025

(51) Int. Cl. H04L 9/08; H04L 45/00

(52) U.S. Cl. CPC H04L 9/0825; H04L 9/0861; H04L 45/566

(57) ABSTRACT

A method for packet path detection includes intercepting a packet of a packet stream that is transmitted from a first host toward a second host over a network, generating a public key/private key pair for the packet stream, and inserting in the packet a hop-by-hop header with the public key. Each node that receives the packet with the hop-by-hop header encrypts a node ID of the node using the public key and configured to store the encrypted node ID in a data structure. The method includes, after at least partially transmitting the packet stream, retrieving the data structure from each node, using the private key to attempt to decrypt entries in the data structure, and deriving a packet path of the packet stream. The packet path includes nodes of the network having one or more entries in the data structure thereof that are successfully decrypted using the private key.

### FIELD

The subject matter disclosed herein relates to determining data paths and more particularly relates to determining a data path using a public key/private key pair.

### BACKGROUND

Network optimization and debugging is difficult when having to deal with large networks, multiple traffic streams and/or multiple network protocols. A network administrator might be under the impression that the traffic is routed/forwarded on a certain path when that is not the case. Having a reliable method to track a packet as it traverses a network can significantly help a system administer understand how to improve/optimize the flow or where a problem might be. Existing methods for determining the path that a packet takes through the network are either unreliable, not applicable to certain network devices, not scalable or require additional hardware.

### BRIEF SUMMARY

A method for packet path detection using a public key/private key pair is disclosed. An apparatus and system also perform the functions of the method. The method includes intercepting a packet of a packet stream that is transmitted from a first host toward a second host over a computer network, and generating a public key and a corresponding private key for the packet stream. The method includes inserting in the packet a hop-by-hop header with the public key. Each node in the computer network that receives the packet with the hop-by-hop header is configured to encrypt a node identifier (“ID”) of the node using the public key inserted in the packet and configured to store the encrypted node ID in a data structure on the node. The method includes, in response to the packet stream being at least partially transmitted by the first host, retrieving the data structure from each node of the computer network, using the private key to attempt to decrypt entries in the data structure of each node of the computer network, and deriving a packet path of the packet of the packet stream. The packet path includes nodes of the computer network having one or more entries in the data structure thereof that are successfully decrypted using the private key.

An apparatus for deriving a data path using a public key/private key pair includes a processor and non-transitory computer readable storage media storing code. The code is executable by the processor to perform operations that include intercepting a packet of a packet stream that is transmitted from a first host toward a second host over a computer network, generating a public key and a corresponding private key for the packet stream, and inserting in the packet a hop-by-hop header that includes the public key. Each node in the computer network that receives the packet with the hop-by-hop header is configured to encrypt a node ID of the node using the public key inserted in the packet and configured to store the encrypted node ID in a data structure on the node. The operations include, in response to the packet stream being at least partially transmitted by the first host, retrieving the data structure from each node of the computer network, using the private key to attempt to decrypt entries in the data structure of each node of the computer network, and deriving a packet path of the packet of the packet stream. The packet path includes nodes of the computer network having one or more entries in the data structure thereof that are successfully decrypted using the private key.

A system for packet path detection using a public key/private key pair includes a plurality of nodes of a computer network, and a network controller with a processor and non-transitory computer readable storage media storing code. The code is executable by the processor to perform operations that include intercepting a packet of a packet stream that is transmitted from a first host toward a second host over the computer network, generating a public key and a corresponding private key for the packet stream, and inserting in the packet a hop-by-hop header that includes the public key. Each of the plurality of nodes in the computer network that receives the packet with the hop-by-hop header is configured to encrypt a node ID of the node using the public key inserted in the packet and configured to store the encrypted node ID in a data structure on the node. The operations include, in response to the packet stream being at least partially transmitted by the first host, retrieving the data structure from each node of the plurality of nodes of the computer network, using the private key to attempt to decrypt entries in the data structure of each node of the plurality of nodes of the computer network, and deriving a packet path of the packet of the packet stream. The packet path includes nodes of the plurality of nodes of the computer network having one or more entries in the data structure thereof that are successfully decrypted using the private key.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for packet path detection using a public key/private key pair, according to various embodiments;

FIG. 2 is a schematic block diagram illustrating an apparatus for packet path detection using a public key/private key pair, according to various embodiments;

FIG. 3 is a schematic block diagram illustrating another apparatus for packet path detection using a public key/private key pair, according to various embodiments;

FIG. 4 is a schematic block diagram illustrating a header of a packet with a hop-by-hop header with a public key, according to various embodiments;

FIG. 5 is a schematic flow chart diagram illustrating a method for packet path detection using a public key/private key pair, according to various embodiments; and

FIG. 6 is a schematic flow chart diagram illustrating another method for packet path detection using a public key/private key pair, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and “excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for packet path detection using a public key/private key pair is disclosed. An apparatus and system also perform the functions of the method. The method includes intercepting a packet of a packet stream that is transmitted from a first host toward a second host over a computer network, and generating a public key and a corresponding private key for the packet stream. The method includes inserting in the packet a hop-by-hop header with the public key. Each node in the computer network that receives the packet with the hop-by-hop header is configured to encrypt a node identifier (“ID”) of the node using the public key inserted in the packet and configured to store the encrypted node ID in a data structure on the node. The method includes, in response to the packet stream being at least partially transmitted by the first host, retrieving the data structure from each node of the computer network, using the private key to attempt to decrypt entries in the data structure of each node of the computer network, and deriving a packet path of the packet of the packet stream. The packet path includes nodes of the computer network having one or more entries in the data structure thereof that are successfully decrypted using the private key.

In some embodiments, the method includes inserting the hop-by-hop header with the public key in each packet of the packet stream. In other embodiments, intercepting the packet of the packet stream includes identifying a file to be transmitted from the first host to the second host, and intercepting the packets of a packet stream associated with the file. In other embodiments, the public key and the private key are generated to be unique to the packet stream within the computer network. In other embodiments, the node in the computer network is configured to encrypt, using the public key, an indicator of an ingress port where the packet was received and to store the encrypted indicator of the ingress port in the data structure on the node.

In some embodiments, each node in the computer network is a switch. In other embodiments, the method includes transmitting an instruction to each node of the computer network to delete entries in the data structure that are older than a threshold amount of time. In other embodiments, the data structure of each node includes a timestamp associated with each entry, and using the private key to attempt to decrypt entries in the data structure of each node of the computer network and deriving a packet path of the packet of the packet stream includes attempting to decrypt entries of the data structure of each node of the computer network using the private key, where the entries each have a timestamp after a start time of beginning to transmit the packet stream, and identifying which nodes comprise an entry decrypted by the private key. In other embodiments, the method includes, in response to retrieving the data structure from each node of the computer network, transmitting an instruction to delete entries in the data structures of the nodes of the computer network.

An apparatus for deriving a data path using a public key/private key pair includes a processor and non-transitory computer readable storage media storing code. The code is executable by the processor to perform operations that include intercepting a packet of a packet stream that is transmitted from a first host toward a second host over a computer network, generating a public key and a corresponding private key for the packet stream, and inserting in the packet a hop-by-hop header that includes the public key. Each node in the computer network that receives the packet with the hop-by-hop header is configured to encrypt a node ID of the node using the public key inserted in the packet and configured to store the encrypted node ID in a data structure on the node. The operations include, in response to the packet stream being at least partially transmitted by the first host, retrieving the data structure from each node of the computer network, using the private key to attempt to decrypt entries in the data structure of each node of the computer network, and deriving a packet path of the packet of the packet stream. The packet path includes nodes of the computer network having one or more entries in the data structure thereof that are successfully decrypted using the private key.

In some embodiments, the operations further include inserting the hop-by-hop header with the public key in each packet of the packet stream. In other embodiments, intercepting the packet of the packet stream includes identifying a file to be transmitted from the first host to the second host, and intercepting the packets of a packet stream associated with the file. In other embodiments, the public key and the private key are generated to be unique to the packet stream within the computer network. In other embodiments, the node in the computer network is configured to encrypt, using the public key, an indicator of an ingress port where the packet was received and to store the encrypted indicator of the ingress port in the data structure on the node. In other embodiments, each node in the computer network is a switch. In other embodiments, the operations further include transmitting an instruction to each node of the computer network to delete entries in the data structure therein that are older than a threshold amount of time.

In some embodiments, the data structure of each node includes a timestamp associated with each entry, and using the private key to attempt to decrypt entries in the data structure of each node of the computer network and deriving a packet path of the packet of the packet stream includes attempting to decrypt entries of the data structure of each node of the computer network using the private key, the entries each have a timestamp after a start time of beginning to transmit the packet stream, and identifying which nodes comprise an entry decrypted by the private key. In other embodiments, the operations further include, in response to retrieving the data structure from each node of the computer network, transmitting an instruction to delete in the data structures of the nodes of the computer network.

A system for packet path detection using a public key/private key pair includes a plurality of nodes of a computer network, and a network controller with a processor and non-transitory computer readable storage media storing code. The code is executable by the processor to perform operations that include intercepting a packet of a packet stream that is transmitted from a first host toward a second host over the computer network, generating a public key and a corresponding private key for the packet stream, and inserting in the packet a hop-by-hop header that includes the public key. Each of the plurality of nodes in the computer network that receives the packet with the hop-by-hop header is configured to encrypt a node ID of the node using the public key inserted in the packet and configured to store the encrypted node ID in a data structure on the node. The operations include, in response to the packet stream being at least partially transmitted by the first host, retrieving the data structure from each node of the plurality of nodes of the computer network, using the private key to attempt to decrypt entries in the data structure of each node of the plurality of nodes of the computer network, and deriving a packet path of the packet of the packet stream. The packet path includes nodes of the plurality of nodes of the computer network having one or more entries in the data structure thereof that are successfully decrypted using the private key.

In some embodiments, the system includes transmitting an instruction to each node of the computer network to delete entries in the data structure therein that are older than a threshold amount of time.

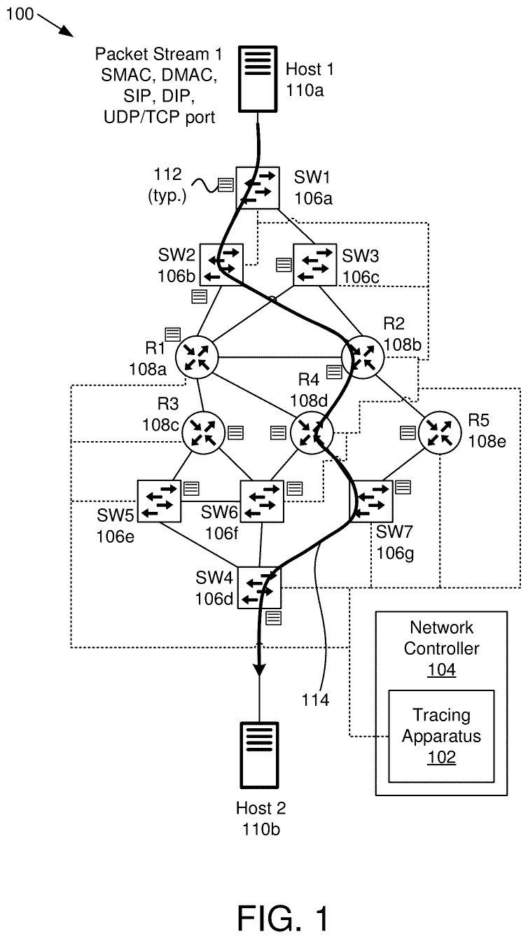

FIG. 1 is a schematic block diagram illustrating a system 100 for packet path detection using a public key/private key pair, according to various embodiments. The system 100 includes a tracing apparatus 102 in a network controller that is connected to each node of a computer network (or simply “network”) with nodes. The nodes are switches 106a-106g and routers 108a-108e connected between a first host 110a and a second host 110b. In other embodiments, the nodes may include other devices that receive and transmit packets. Each node includes a table or other data structure 112 that includes encrypted node identifiers (“IDs”). The system 100 is described in detail below. Each node includes a unique node ID, which may be an internet protocol (“IP”) address, a media access control (“MAC”) address, a name assigned by the network controller 104, or the like. In some embodiments, the unique node ID is unique within the computer network between the first host 110a and the second host 110b.

The tracing apparatus 102 is configured to intercept a packet of a packet stream where the packet stream is to be transmitted from the first host 110a to the second host 110b over the computer network and is configured to generate a public key and a corresponding private key (e.g., public key/private key pair) for the packet stream. The tracing apparatus 102 is configured to insert in the packet a in a hop-by-hop header where the hop-by-hop header includes the public key. Hop-by-hop headers are available for packets formatted using the internet protocol version 6 (“IPv6”).

As the packet is transmitted through the network, each node detects the public key in the hop-by-hop header and uses the public key to encrypt a node identifier (“ID”) and stores the encrypted node ID in a data structure 112 located at the node. The data structure 112 may be a database, a table, or the like. Once the packet stream has been transmitted, the tracing apparatus 102 is configured to retrieve the data structure 112 from each node in the network. The tracing apparatus 102 is configured to retrieve the private key and use the private key to attempt to decode each entry in the data structure 112 of each node and is configured to derive a packet path 114 of the packet stream where the packet path 114 includes nodes of the computer network with one or more entries in the data structure of the nodes with decrypted node IDs that were decrypted using the private key.

The system 100 includes a network controller 104 that is connected to each node of the computer network. In some embodiments, the network controller 104 receives information from the nodes, such as traffic information about ingress and egress ports, node status information, and the like. In other embodiments, the network controller 104 sends commands, software updates, etc. to the nodes of the network. In some embodiments, the nodes of the network are part of a private network.

The switches 106a-106g (generically or individually “106”) are typically configured as a bridge that provides better connections. Some switches 106 set up data packets for transmission and stops data packets received from routers 108a-108e (generically or individually “108”) and remove upper network layer before being sent to a final destination. Some switches 106 are managed switches, which can be customized for the network. In some cases, some switches 106 of the network operate as a gateway. In other embodiments, routers 108 operate as gateways. Some switches 106 are unmanaged switches that receive and transmit data packets, typically within a local network located between a gateway and hosts 110. In some embodiments, switches 106 operate to increase a bandwidth of a network by reducing frame collisions. One of skill in the art will recognize other features and functions of switches 106.

The routers 108 typically operate at the network layer 3 and function to transmit data packets along a specific route. Often routers 108 operate via a routing table that includes connections between the routers 108. Often routers 108 transmit packets based on an internet protocol (“IP”) addresses inserted in the network layer 3 of each data packet. In some embodiments, the routers 108 are wireless routers connected to other routers via a wireless connection. In other embodiments, the routers 108 and/or switches 106 are connected with cables, fiber connections, or the like. The network may include a LAN, a WAN, a fiber network, a wireless network, or the like and may include multiple network types. Typically, routers 108 are accessed using a user ID and a password. Often routers 108 using a router table route data packets via a most efficient packet path 114. Typically, routers 108 include multiple ingress ports and/or multiple egress ports. Data packets on a packet stream typically enter a router 108 via an ingress port and leave the router 108 via an egress port.

In the system 100, each node 106, 108 includes a data structure 112 that includes entries where each entry is an encrypted node ID of a packet stream that has been encrypted using a public key of each packet stream. The data structure 112 may be a list, a database, a file, or the like. The data structure 112 has a limited length and in some embodiments, the nodes include an entry deletion module 302 that transmits and instruction to delete the oldest entries in the data structure 112. In some embodiments, the entry deletion module 302 transmits the instruction to delete the oldest entries to each node 106, 108. In some examples, entries over 5 minutes are deleted. In other embodiments, the time limit is set to a different value. In other embodiments, the data structure 112 is a first-in first-out register and entries at the end of the register are dropped when a new entry is added. The register, in some embodiments, is large enough to include enough entries to cover an adequate amount of time for a user to retrieve entries from the data structure of the various nodes of the network after a packet stream has been transmitted.

The first host 110a and the second host 110b may include a rack-mounted server, a blade server, a desktop computer, a workstation, a laptop computer, or other computing device. In some embodiments, a host 110a, 110b (generically or individually “110”) is an endpoint in computer network that is connected to multiple computing devices over the network. In other embodiments, a location may have numerous hosts 110, each capable to transmitting a packet stream over the nodes 106, 108 of the network.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ). Alternatively, the wireless connection may be a cellular telephone network communication. All standards and/or connection types include the latest version and revision of the standard and/or connection type as of the filing date of this application.

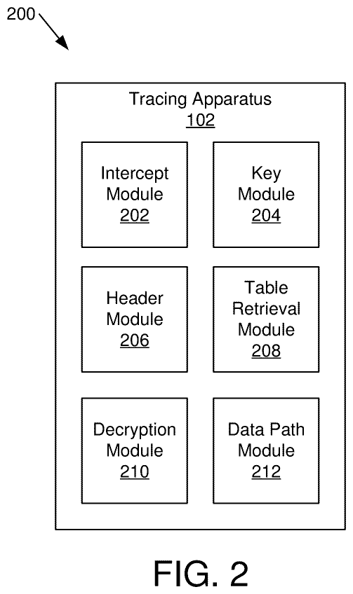

FIG. 2 is a schematic block diagram illustrating an apparatus 200 for packet path detection using a public key/private key pair, according to various embodiments. The apparatus 200 includes a tracing apparatus 102 with an intercept module 202, a key module 204, a header module 206, a table retrieval module 208, a decryption module 210, and a data path module 212, which are described below. In some embodiments, the apparatus 200 is implemented with executable code stored on computer readable storage media. In other embodiments, all or a portion of the apparatus 200 is implemented using a programmable hardware device and/or hardware circuits.

The apparatus 200 includes an intercept module 202 configured to intercept a packet of a packet stream. The packet stream is to be transmitted from a first host 110a toward a second host 110b over a computer network, such as the switches 106 and routers 108 depicted in the system 100 of FIG. 1. In some embodiments, the packet stream is to be examined. In some examples, a user may be noticing that a particular file or file type being transmitted from the first host 110a to the second host 110b is too slow or maybe packets are not being received at the second host 110b. The user may then interact with the intercept module 202 and/or the tracing apparatus 102 to enter an ID for the first host 110a as the transmitting host and to enter an ID of the second host 110b as the receiving host. The user may also enter other information, such as the file type, a file identifier, live data stream, or the like to be used by the intercept module 202 to know which packet stream to intercept. In some embodiments, the intercept module 202 reads the source address and destination address to identify which packets to intercept. One of skill in the art will recognize other ways for the intercept module 202 to be programmed to intercept packets from the packet stream of interest.

The apparatus 200 includes a key module 204 configured to generate a public key and a corresponding private key for the packet stream. The public key/private key pair is generated specifically for the packet stream so that the public key and the private key are used by the tracing apparatus 102 to identify the packet path of the packet stream. With a public key/private key pair, the public key is used for encryption and the private key is used for decryption. A node of the network use the public key to encrypt the node ID of the node. The node may also use the public key to encrypt other information with the node ID, such as an indicator of the ingress port where a packet with the public key entered the node. The indicator may be a port ID or other name for the ingress port. The node stores the encrypted node ID in a data structure 112 on the node. The key module 204, in various embodiments, may use OpenSSL® (SSL stands for Secure Socket Layer), SSH-Keygen (SSH stands for Secure Shell), GNU Privacy Guard (“GPG”) (GNU is a recursive acronym that stands for GNU's not Unix), or the like.

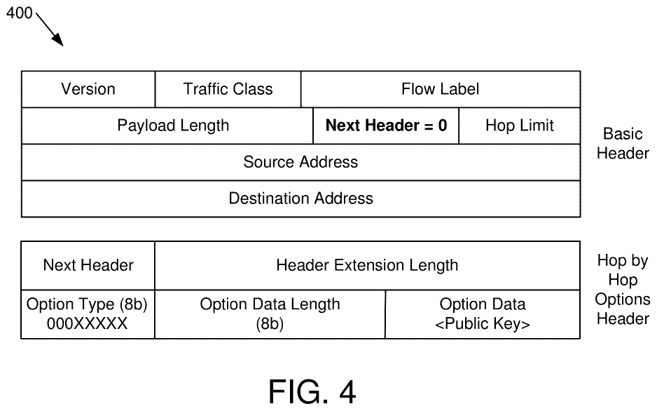

The apparatus 200 includes a header module 206 configured to insert in the packet a hop-by-hop header that includes the public key. A hop-by-hop header structure is explained in relation to FIG. 4. Each node in the computer network receiving the packet with the hop-by-hop header is configured to encrypt a node ID of the node and to store the encrypted node ID in a data structure 112 on the node. FIG. 4 is a schematic block diagram illustrating a header of a packet with a hop-by-hop header with a public key, according to various embodiments. The box on top is symbolic of a typical basic packet header for IPv6 packets. The header includes information such as the version number of the packet, the traffic class of the packet, and a flow label of the packet.

The version number indicates if the packet is IPv4 or IPv6. Embodiments described herein use IPv6, which includes hop-by-hop headers where IPv4 does not include a hop-by-hop header. The traffic class or type of service identifies the quality of service for the packet. The flow label is used by a source to label the packets belonging to the same flow to request special handling by intermediate IPv6 routers, such as non-default quality of service or real time service.

The next line includes payload length, a next header field, and a hop limit. The payload length indicates a total size of the payload, which tells routers the amount of information the packet contains. The next header field indicates if there is a next header after the basic header and also indicates the type of extension header immediately following the basic IPv6 header. A hop-by-hop header has a code of zero. In some cases, the next header field is used to indicate a protocol contained in upper-layer packets, such as transmission control protocol (“TCP”) or user datagram protocol (“UDP”).

The hop limit field indicates the maximum number of intermediate nodes the IPv6 packet is allowed to travel. The value of the hop limit field gets decremented by one at each node visited by the packet. If the values is zero, the packet is discarded. This is used to discard packets caught in an infinite loop of nodes because a routing error. The source address includes the address of the source of the packet flow, which in FIG. 1 is the address of the first host 110a. The destination address includes the address of the destination of the packet flow, which in FIG. 1 is the address of the second host 110b.

The second box in FIG. 4 is a hop-by-hop header. The hop-by-hop header includes a next header field and an header extension length field in the first line. The next header field includes a code for a next header or a code indicating that there is no next header. The header extension length includes the number of 8-byte blocks in the hop-by-hop options fields below the first line. Length of the hop-by-hop options field is in 8-octet units, not including the first 8 octets.

The second line of the hop-by-hop header includes an option type field, an option data length field, and the option data. The option type field includes information about the option. The first two bits being 00 indicates to skip the option if the processing IPv6 node does not recognize the Option Type. Other combinations of the first two bits could be 01: silently discard the packet, 10: discard the packet and send a parameter problem message to the sender if the destination address is a unicast or a multicast address, or 11: discard the packet and send a problem message if the destination address field is not a multicast address. The third digit of the option type field is 1 if the option data can change or 0 if the option data cannot change. In the option type field, the (8d) indicates that the field length is 8 bits. The remaining bits after the first three can be anything as long as the Option Type is unique for this use case. The remaining bits are depicted with an X. In some embodiments, the last five bits are set to a value that indicates that the option data includes a public key.

The option data length field indicates the length of the option type field. FIG. 4 depicts an 8d indicating that the option type field is 8 bits. The option data field, in the embodiments described herein, include the public key. The nodes are programmed to identify, using the Option Type value, that the option data includes a public key. Where a node identifies that the option data includes a public key, the node uses the public key to encrypt the node ID and to store the encrypted node ID in a data structure on the node. The header module 206 inserts the public key in the option data field of the hop-by-hop header and inserts into the option type field a binary number with the first three bits of 000 and the last five bits to be other 1s and 0s. In some embodiments, the last 5 bits are a code that indicates to the nodes that the option data includes a public key. In other embodiments, the last 5 bits are not used and are set to some value and the nodes are programmed to read the option data field and recognize that the option data includes a public key or some data presumed to be a public key. In the embodiment, the value of the 5 bits are set to a value that will not trigger some other action.

The apparatus 200 includes a table retrieval module 208 configured to retrieve the data structure 112 from each node of the computer network after the packet stream has been sent. As used herein, retrieving the data structure 112 includes retrieving and/or reading the contents of the data structures 112. In some embodiments, the table retrieval module 208 verifies that the packet stream has been received at the destination host (e.g., second host 110b) or a sufficient amount of time has passed that the packet stream should have been received before retrieving the data structures 112. The table retrieval module 208 uses the network controller 104, which is connected to each node in the network, to retrieve a data structure 112 from each node. The data structure 112 includes entries with encrypted node IDs. In some embodiments, the table retrieval module 208 reads the data structure 112 of each node and stores the read entries in a similar data structure available to the network controller 104 and labeled with the node ID or otherwise identified as pertaining to the node where the data structure 112 was read by the table retrieval module 208. In some embodiments, the table retrieval module 208 retrieving the data structure 112 from each node of the computer network merely includes the table retrieval module 208 reading the entries from each data structure 112, as described below in conjunction with the decryption module 210.

The apparatus 200 includes a decryption module 210 configured to use the private key to attempt to decrypt entries in the data structure 112 of each node of the computer network. In some embodiments, the decryption module 210 goes through each data structure 112 of the various nodes line-by-line attempting to decrypt each entry using the private key and then increases a counter for each entry that is decrypted into a node ID that matches the node ID of the data structure 112. In other embodiments, the decryption module 210 goes through the data structures 112 and replaces entries successfully decrypted with the private key with the node ID. In further embodiments, the decryption module 210 counts the number of entries decrypted into the node ID. In some embodiments, each entry in the data structure 112 includes a timestamp and the decryption module 210 attempts to decrypt entries of the data structure 112 of each node 106. 108 using the private key where the entries each have a timestamp after a time of beginning to transmit the packet stream.

In other embodiments, the decryption module 210 merely sets a flag associated with a particular data structure 112 to indicate that at least one entry in the data structure 112 was successfully decrypted. In the embodiment, an unsuccessful decryption attempt would not affect a set flag. Thus, one or more successful decryptions would result in the flag of a data structure 112 to be set. In other embodiments, the decryption module 210 processes multiple data structures 112 of nodes in the network at the same time. In some embodiments, the tracing apparatus 102 does not include a table retrieval module 208 and the decryption module 210 decrypts the entries in the data structures 112 located the nodes. In some embodiments, the table retrieval module 208 retrieving the data structure 112 from each node of the computer network merely includes the table retrieval module 208 reading the entries from each data structure 112, and as the entries are read the decryption module 210 in the process of attempting to decrypt entries of the data structure 112 using the private key. One of skill in the art will recognize other ways for the table retrieval module 208 and the decryption module 210 retrieve/read the entries of the data structures 112 of the nodes and to use the private key to attempt to decrypt entries in the data structure 112 of each node of the network.

The apparatus 200 includes a data path module 212 configured to derive a packet path of the packet of the packet stream. The packet path includes nodes of the computer network with one or more entries in the data structure 112 of the nodes with decrypted node IDs decrypted using the private key. In some embodiments, the data path module 212 accesses results of the decryption module 210 to identify which nodes include entries with decrypted node IDs. In some examples where the decryption module 210 changed a flag or similar action to identify nodes with decrypted entries, the data path module 212 reads the flags or similar data structure 112 to identify the nodes in the data path. In other embodiments, the data path module 212 reads data structures 112 associated with each node of the network to identify which data structures 112 include entries with decrypted node IDs that match the node ID of the data structure 112.

In other embodiments where the decryption module 210 increases a counter for each node with an entry that is decrypted with the private key, the data path module 212 identifies counters of nodes with a value greater than zero or above a threshold. In some embodiments, a few packets of the packet stream may have traveled a different path than other packets of the packet stream so that having a threshold high enough the exclude the few packets traveling a different path is used by the data path module 212 to identify the main data path of the packets of the packet stream. One of skill in the art will recognize other ways that the data path module 212 is able to derive a packet path of the packets of the packet stream.

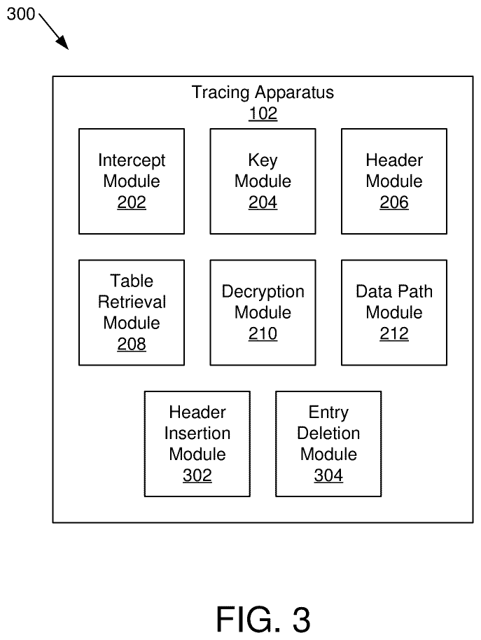

FIG. 3 is a schematic block diagram illustrating another apparatus 300 for packet path detection using a public key/private key pair, according to various embodiments. The apparatus 300 includes another tracing apparatus 102 with an intercept module 202, a key module 204, a header module 206, a table retrieval module 208, a decryption module 210, and a data path module 212, which are substantially similar to those described above with regard to the apparatus 200 of FIG. 2. In various embodiments, the apparatus 300 includes a header insertion module 302 and/or an entry deletion module 304, which are described below. In some embodiments, the apparatus 300 is implemented with executable code stored on computer readable storage media. In other embodiments, all or a portion of the apparatus 300 is implemented using a programmable hardware device and/or hardware circuits.

The apparatus 300, in some embodiments, includes a header insertion module 302 configured to insert the hop-by-hop header with the public key in each packet of the packet steam. In some embodiments, the header insertion module 302 works in conjunction with the header module 206 that creates the hop-by-hop header with the public key and the header insertion module 302 then inserts the hop-by-hop header with the public key into each packet of the packet stream as the packets are received. In some embodiments, the header insertion module 302 works in conjunction with the first host 110a to insert the hop-by-hop header with the public key. In some embodiments, all or a portion of the header insertion module 302 and/or the header module 206 are included in the first host 110a and/or other hosts 110. In other embodiments, all or a portion of the header insertion module 302 and/or the header module 206 are included in nodes connected to hosts 110, such as switch SW1 106a and host SW4 106d.

The apparatus 300, in some embodiments, includes an entry deletion module 304 configured to delete entries in the data structures 112 of the nodes of the computer network. In some embodiments, the entry deletion module 304 deletes entries older than a threshold amount of time, such as 5 minutes or 10 minutes. In some embodiments, the entry deletion module 304 allows a user to set the threshold amount of time, which may be long enough to transmit the packet stream and for the table retrieval module 208 to retrieve/read entries from the data structures 112 of the nodes. The entry deletion module 304 beneficially provides a way to limit entries in the data structures of the nodes with encrypted node IDs. In other embodiments, the data structures 112 are in the form of registers with a first in first out structure and once the register is full, the entries roll off the end when new entries come in. In another embodiment, the data structures 112 are set up so that entries are added in a particular order and once the data structures 112 are full, the nodes overwrite the oldest entries with new entries.

In some embodiments, the entry deletion module 304 deletes, in response to retrieving the data structure 112 from each node of the computer network, entries in the data structures 112 of the nodes of the computer network. In some embodiments, where the decryption module 210 fails to decrypt some entries and the entries remain untouched or where the decryption module 210 repairs entries that were attempted to be decrypted and the decryption failed, the entry deletion module 304 deletes decrypted entries while leaving the encrypted entries. In other embodiments, the entry deletion module 304 deletes all entries of the data structures 112 in preparation for further operations with other packet streams being examined and where the nodes encrypt the node IDs when a public key is present in the packets of the packet streams.

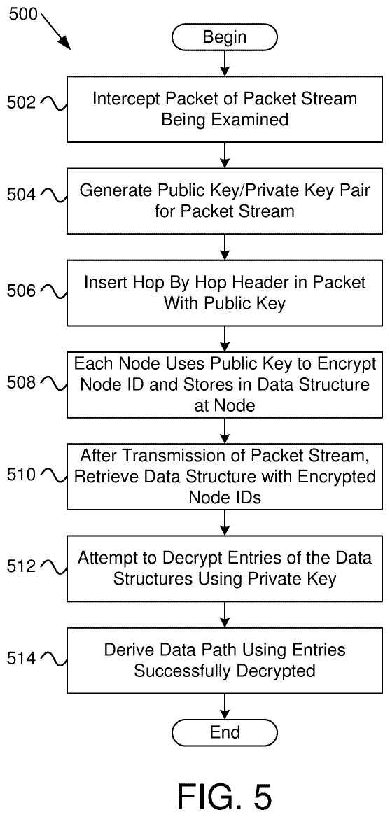

FIG. 5 is a schematic flow chart diagram illustrating a method 500 for packet path detection using a public key/private key pair, according to various embodiments. The method 500 begins and intercepts 502 a packet of a packet stream. The packet stream is to be transmitted from the first host 110a to the second host 110b over a computer network, such as the computer network of the system 100 of FIG. 1. The method 500 generates 504 a public key and a corresponding private key for the packet stream. The public key/private key pair is exclusive to the packet stream.

The method 500 inserts 506 in the packet a hop-by-hop header that includes the public key. Each node in the computer network receiving the packet with the hop-by-hop header is configured to encrypt 508 a node ID of the node and to store the encrypted node ID in a data structure 112 on the node. The method 500 retrieves 510, after transmission of the packet stream, the data structure 112 from each node of the computer network and attempts 512 to decrypt entries of the data structure 112 of each node of the computer network using the private key. The method 500 derives 514 a packet path of the packet of the packet stream, and the method 500 ends. The packet path includes nodes of the computer network with one or more entries in the data structure 112 of the nodes with decrypted node IDs decrypted using the private key. In various embodiments, all or a portion of the method 500 is implemented using the intercept module 202, the key module 204, the header module 206, the table retrieval module 208, the decryption module 210, and/or the data path module 212.

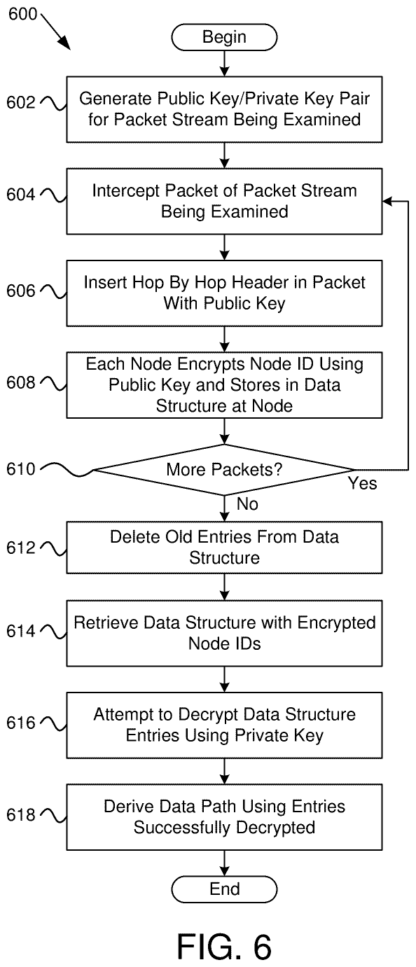

FIG. 6 is a schematic flow chart diagram illustrating another method 600 for packet path detection using a public key/private key pair, according to various embodiments. The method 600 begins and generates 602 a public key and a corresponding private key for a packet stream being examined. The packet stream is to be transmitted from a first host 110a toward a second host 110b over a computer network, such as the computer network of the system 100 of FIG. 1. The method 600 intercepts 604 a packet of the packet stream being examined and inserts 606 in the packet a hop-by-hop header that includes the public key. The method 600, for each node in the computer network receiving the packet with the hop-by-hop header, encrypts 608 a node ID of the node and stores the encrypted node ID in a data structure 112 on the node. Th method 600 determines 610 if there are more packets in the packet stream.

If the method 600 determines 610 that there are more packets in the packet stream, the method 600 returns and intercepts 604 the next packet in the packet stream. If the method 600 determines 610 that there are no more packets in the packet stream to be sent, the method 600 deletes old entries from the data structures 112 of the nodes. In some embodiments, the old entries are past a threshold time limit, such as 5 minutes or 10 minutes. The method 600 retrieves 614 (or reads) the data structure 112 from each node of the computer network and attempts 616 to decrypt the data structure entries using the private key. The method 600 derives 618 the data path, and the method 600 ends. The data path includes nodes of the computer network with one or more entries in the data structures 112 of the nodes with decrypted node IDs decrypted using the private key. In various embodiments, all or a portion of the method 600 is implemented using the intercept module 202, the key module 204, the header module 206, the table retrieval module 208, the decryption module 210, the data path module 212, a header insertion module 302, and/or an entry deletion module 304.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
intercepting a packet of a packet stream that is transmitted from a first host toward a second host over a computer network;
generating a public key and a corresponding private key for the packet stream;
inserting in the packet a hop-by-hop header comprising the public key, wherein each node in the computer network that receives the packet with the hop-by-hop header is configured to encrypt a node identifier (“ID”) of the node using the public key inserted in the packet and configured to store the encrypted node ID in a data structure on the node;
in response to the packet stream being at least partially transmitted by the first host, retrieving the data structure from each node of the computer network;
using the private key to attempt to decrypt entries in the data structure of each node of the computer network; and
deriving a packet path of the packet of the packet stream, the packet path comprising nodes of the computer network having one or more entries in the data structure thereof that are successfully decrypted using the private key.

2. The method of claim 1, further comprising inserting the hop-by-hop header with the public key in each packet of the packet stream.

3. The method of claim 1, wherein intercepting the packet of the packet stream comprises:
identifying a file to be transmitted from the first host to the second host; and
intercepting the packets of a packet stream associated with the file.

4. The method of claim 1, wherein the public key and the private key are generated to be unique to the packet stream within the computer network.

5. The method of claim 1, wherein the node in the computer network is configured to encrypt, using the public key, an indicator of an ingress port where the packet was received and to store the encrypted indicator of the ingress port in the data structure on the node.

6. The method of claim 1, wherein each node in the computer network is switch.

7. The method of claim 1, further comprising transmitting an instruction to each node of the computer network to delete entries in the data structure therein that are older than a threshold amount of time.

8. The method of claim 1, wherein the data structure of each node includes a timestamp associated with each entry, and wherein using the private key to attempt to decrypt entries in the data structure of each node of the computer network and deriving a packet path of the packet of the packet stream comprises:
attempting to decrypt entries of the data structure of each node of the computer network using the private key, the entries each having a timestamp after a start time of beginning to transmit the packet stream; and
identifying which nodes comprise an entry decrypted by the private key.

9. The method of claim 1, further comprising, in response to retrieving the data structure from each node of the computer network, transmitting an instruction to delete entries in the data structures of the nodes of the computer network.

10. An apparatus comprising:
a processor; and
non-transitory computer readable storage media storing code, the code being executable by the processor to perform operations comprising:
intercepting a packet of a packet stream that is transmitted from a first host toward a second host over a computer network;
generating a public key and a corresponding private key for the packet stream;
inserting in the packet a hop-by-hop header comprising the public key, wherein each node in the computer network that receives the packet with the hop-by-hop header is configured to encrypt a node identifier (“ID”) of the node using the public key inserted in the packet and configured to store the encrypted node ID in a data structure on the node;
in response to the packet stream being at least partially transmitted by the first host, retrieving the data structure from each node of the computer network;
using the private key to attempt to decrypt entries in the data structure of each node of the computer network; and
deriving a packet path of the packet of the packet stream, the packet path comprising nodes of the computer network having one or more entries in the data structure thereof that are successfully decrypted using the private key.

11. The apparatus of claim 10, wherein the operations further comprise inserting the hop-by-hop header with the public key in each packet of the packet stream.

12. The apparatus of claim 10, wherein intercepting the packet of the packet stream comprises:
identifying a file to be transmitted from the first host to the second host; and
intercepting the packets of a packet stream associated with the file.

13. The apparatus of claim 10, wherein the public key and the private key are generated to be unique to the packet stream within the computer network.

14. The apparatus of claim 10, wherein the node in the computer network is configured to encrypt, using the public key, an indicator of an ingress port where the packet was received and to store the encrypted indicator of the ingress port in the data structure on the node.

15. The apparatus of claim 10, wherein each node in the computer network is a switch.

16. The apparatus of claim 10, wherein the operations further comprise transmitting an instruction to each node of the computer network to delete entries in the data structure therein that are older than a threshold amount of time.

17. The apparatus of claim 10, wherein the data structure of each node includes a timestamp associated with each entry, and wherein using the private key to attempt to decrypt entries in the data structure of each node of the computer network and deriving a packet path of the packet of the packet stream comprises:
attempting to decrypt entries of the data structure of each node of the computer network using the private key, the entries each having a timestamp after a start time of beginning to transmit the packet stream; and
identifying which nodes comprise an entry decrypted by the private key.

18. The apparatus of claim 10, wherein the operations further comprise, in response to retrieving the data structure from each node of the computer network, transmitting an instruction to delete entries in the data structures of the nodes of the computer network.

19. A system comprising:
a plurality of nodes of a computer network; and
a network controller comprising a processor and non-transitory computer readable storage media storing code, the code being executable by the processor to perform operations comprising:
intercepting a packet of a packet stream that is transmitted from a first host toward a second host over the computer network;
generating a public key and a corresponding private key for the packet stream;
inserting in the packet a hop-by-hop header comprising the public key, wherein each of the plurality of nodes in the computer network that receives the packet with the hop-by-hop header is configured to encrypt a node identifier (“ID”) of the node using the public key inserted in the packet and configured to store the encrypted node ID in a data structure on the node;
in response to the packet stream being at least partially transmitted by the first host, retrieving the data structure from each node of the plurality of nodes of the computer network;
using the private key to attempt to decrypt entries in the data structure of each node of the plurality of nodes of the computer network; and
deriving a packet path of the packet of the packet stream, the packet path comprising nodes of the plurality of nodes of the computer network having one or more entries in the data structure thereof that are successfully decrypted using the private key.

20. The system of claim 19, further comprising transmitting an instruction to each node of the computer network to delete entries in the data structure therein that are older than a threshold amount of time.
